(19) United States
(12) Patent Application Publication
(10) Pub. No.: US 2020/0246120 A1
(43) Pub. Date: Aug. 6, 2020

(54) Polymerization And Tempering Device

(71) Applicant: Ivoclar Vivadent AG, Schaan (LI)

(72) Inventor: Oliver Benz, Schaan (LI)

(21) Appl. No.: 16/774,159

(22) Filed: Jan. 28, 2020

(30) Foreign Application Priority Data
Feb. 6, 2019 (EP) 19155640.6

(51) Int. Cl. A61C 13/15; A61C 13/00; B29C 64/245; B29C 64/25; B29C 64/264; B29C 64/364

(52) U.S. Cl. CPC A61C 19/003; A61C 13/0013; B29C 64/245; B33Y 30/00; B29C 64/264; B29C 64/364; B29C 64/25

(57) ABSTRACT

A polymerization and tempering device (10) comprising at least one light source (60) which emits light in the visible and/or ultraviolet wavelength range, and comprising a fan (30), a light chamber (24) and with a door to the light chamber is provided, wherein the polymerization and tempering device is light-proof and the fan is arranged in an air channel (14) which extends through a housing (12) of the polymerization and tempering device (10) and in particular blows air behind at least the light source wall (56).

### CROSS-REFERENCE TO RELATED APPLICATIONS

This application claims priority to European patent application No. 19155640.6 filed on Feb. 6, 2019, the disclosure of which is incorporated herein by reference in its entirety.

### TECHNICAL FIELD

The invention relates to a polymerization and tempering device.

### BACKGROUND

It has been known for long that light-curable plastics may be cured by exposing them to light having a certain wavelength. The preferred wavelength is that of the photoinitiator(s), wherein in case of today's light-curable plastics photoinitiators having a sensitivity maximum of approximately 400 nm and approximately 470 nm are frequently used.

Accordingly, suitable polymerization apparatuses which may also be referred to as light-curing devices comprise emission maxima of the used light-emitting diodes or laser diodes of approximately 400 nm and approximately 470 nm.

In many cases, it has proven favorable to initially carry out only part of the light-curing process and to provide the desired final hardness of the plastic in a concluding step.

Then, for instance, the produced products may be finished better in the not yet completely cured state.

When dental restoration products are produced, edge gaps may still be eliminated, for instance, and shrinkage of the dental restoration part which will possibly take place may be compensated for by an additional layer.

A further example are products, and again in particular dental restoration parts, produced by stereolithograhy in which every layer is cured during slicing to such an extent that the subsequent layer still adheres well.

Then, the finished dental restoration part should be tempered and finally cured in a suitable polymerization and tempering apparatus—while it is still purposefully mounted on the associated construction platform.

It has also become known to support the polymerization process by heat curing. Especially in the field of dental products a—frequently undesired—yellow discoloration may be observed in case of the heat curing process, that is to say when the dental restoration part is impinged with infrared radiation.

Additive manufacturing systems include those set forth in U.S. Pat. Nos. 10,518,328, 10,539,951, 10,538,030, 20200001537, 20200001533, 20200001571, 20190291184, all of which are hereby incorporated by reference in their entirety. Curing devices include those set forth in U.S. Pat. Nos. 10,408,537, 10,390,690, 10,159,548, 10,070,779, 9,987,110, 9,833,133, 9,726,435, 9,693,846, 5,922,605, 5,554,855, 5,803,729, 8,142,052, 20120032575, all of which are hereby incorporated by reference in their entirety.

A polymerization device, as has been used very successfully and pervasively, is the polymerization device known from DE 196 185 42 C2 and corresponding U.S. Pat. No. 5,922,605, which is hereby incorporated by reference in its entirety. In case of this device a dental restoration part is placed on a base as a placement location. Then, a pivotable hood is pulled over the dental restoration part, and then light sources for polymerization and/or heat sources for polymerization may be turned on at user's option.

The light sources surround the dental restoration part and enable high-intensity irradiation such that the desired polymerization process is realizable comparatively fast.

In case of the polymerization device according to the mentioned patent, light sources are arranged all around, that is to say circularly around the dental restoration part. Reflectors provided thereat serve to bundle and focus the emitted light energy onto the dental restoration part.

The required duration for the polymerization process but also for a post-tempering process is favorable based on the light sources used thereat, but not especially short.

A higher light output and accordingly a shorter treatment duration would be desirable especially for tempering partially polymerized dental restoration parts which have been produced by rapid prototyping, in particular by stereolithography. However, light sources of this type cause a corresponding output of heat which requires cooling of the light sources.

However, a fan would be required to cool light sources of this type which is difficult to reconcile with a pivotable hood.

### SUMMARY

Thus, the invention is based on the task of providing an improved polymerization and tempering device in accordance with the claims, which is particularly suitable for curing and post-tempering dental restoration parts which have been produced by stereolithography for instance, while handling advantages such as a shorter treatment duration should still be achievable while the costs are the same or insignificantly higher at most.

This task is inventively solved by the claims. Advantageous developments may be taken from the subclaims.

According to the invention, it is provided initially to realize a special light chamber having a door. The light chamber basically replaces the hood and is stationary and not pivotable. This enables an arrangement of the light sources which are present preferably as light-emitting diodes in the form of a stationary matrix and for cooling them. Cooling is performed by an airflow in an air channel which extends transversely through the housing of the polymerization and tempering device.

The light sources are preferably arranged at a wall or two walls of the light chamber. Then, air of the air channel flows behind this wall; in this respect, the intermediate space between the light chamber wall with the light sources and the outside of the housing is in the air channel.

According to the invention, the polymerization and tempering apparatus or the respective device is light-proof.

Typically, air channels with open inlets and outlets are also permeable to light. However, this is prevented by inventively special measures.

Thus, the ergonomic configuration of the inventive device is improved considerably; in particular if—as is typical—UV light is emitted, the operators would be subjected to considerable UV irradiation otherwise, permanently in fact.

UV irradiation is considered to cause skin cancer and is thus undesired. Additionally, permanent exposure to UV rays is considered to be harmful to the eyes.

Thus, the inventive light tightness is important and may be realized surprisingly easily by the special design of the transversely extending air channel with several redirections.

This means that although air flows through the light chamber and accordingly apertures of the light chamber wall through which light may exit are also provided, redirections of the air channel and in some cases separate screens both on the entry side and on the exit side of the light chamber ensure that light exiting thereat does not reach the outside of the housing.

A test has shown that less than 1 per mil of the output light power reaches the outside when the light source is fully switched on and the ambient space is darkened.

However, UV exposure to this extent is uncritical and is even provided by the sun when the sky is clouded.

According to the invention it is particularly favorable that, by clever arrangement, the air channel extends at least partially on the outside around the light chamber and may cool several heat sources at the same time.

The associated fan is positioned relatively centrally, that is to say spaced apart substantially equally from the inlet and the outlet which is of benefit to the thermal insulation.

In a further advantageous configuration it is provided that the polymerization and tempering device is light-proof such that when the light source is turned on up to 1%, in particular less than 1 per mil, of the light output emitted by the light source escapes to the outside when the door to the light chamber is closed. In this respect, this configuration may be referred to as “light-proof”.

In an advantageous configuration, the inventive air channel starting from an air inlet at a side wall of the housing initially runs through power electronics and mains supply for the entire device which are arranged in a plane below the light chamber.

The air flow is redirected in the air channel by 90 degrees to the top into an ascending branch of the air channel.

There, an axial fan is arranged which sucks or else pushes the air through the air channel.

Subsequent to the fan, the air is guided over an inclined screen and beyond its upper edge such that it flows transversely to the bottom from the upper edge of the screen.

Subsequent to this, the air passes through a light chamber inlet and therethrough arrives at the dental restoration part or the dental restoration parts as a relatively strong blowing flow.

The dental restoration parts are also cooled by the air sweeping over them.

Then, the air leaves the light chamber at a wall, extending transversely to the wall of the light chamber inlet, which comprises the light chamber outlet.

Light chamber inlet and light chamber outlet are vertically offset to one another such that the air flow also obtains an oblique component.

In the preferred exemplary embodiment, the light chamber outlet is provided at the rear wall of the light chamber.

The air flow is redirected again, to the side, and flows around the light chamber on the outside until it arrives at the right side wall.

At the right side wall the air flow is redirected again, and flows behind the wall thereat.

This wall is equipped with a matrix of light-emitting diodes in the upper region. The existing flow of air cools the light-emitting diodes.

The air flow is redirected again at the upper edge of the right light chamber side wall and sweeps over the ceiling wall of the light chamber.

Numerous light-emitting diodes are also arranged thereat, and the flow of air runs to the left across the ceiling wall of the light chamber, below the ceiling wall of the housing.

At the left side wall of the housing an air outlet is configured through which the flow of air leaves the housing.

According to the invention, the special characteristic of the redirections is as follows:

On the one hand, the air redirections are configured to be optimized with regard to flow, for instance with air baffles or respective moldings made of plastic.

On the other hand, every air redirection also serves shading purposes at the same time. This ensures that air redirections added up to at least 225 degrees exist between the light source and the air inlet and the light source and the air outlet:

On the inlet side, the first air redirection of 90 degrees and the second air redirection of 135 degrees are provided. On the outlet side, the third air redirection of 90 degrees, the fourth of 90 degrees and the fifth of 90 degrees are provided, that is to say 270 degrees altogether.

The fan is also provided on the inlet side consciously, as the added-up air redirection angle is larger on the outlet side than on the inlet side, and the fan serves a shading purpose for its part.

Further, the interior of the air channel is configured to be completely black such that incident light is not reflected thereat but absorbed.

In this respect, the air channel has a dual function, that is to say of air delivery and light blockade at the same time.

It is to be understood that it is ensured also as for the rest that no UV light falls to the outside unnecessarily. Thus, the door to the light chamber is equipped with a circumferential labyrinth seal, and there is no gap between the door and the door frame.

The door is also mirrored on the inside, as is the light chamber, if preferable.

It is also favorable that the light sources are arranged at two different walls of the light chamber oblique or perpendicular towards one another. Exposure to light will then take place also in three dimensions, especially if the object to be treated, that is to say for instance a dental restoration part, is mounted on a rotary plate and rotates during polymerization and tempering.

By way of precaution, a rotary plate of this type may be configured to be relatively large and may have a diameter that covers significantly more than half of the floor area of the light chamber. Then, it is possible to set down both smaller and larger dental restoration parts thereat and to treat them, or also for instance a construction platform of a stereolithography device having the still adhering and attached dental restoration parts thereon.

Height and width of the light chamber are also sized such that a construction platform of this type comprising the dental restoration parts to be cured may be accommodated, as well as the door to the light chamber.

It is also particularly favorable that the air flow of the air channel extends through the light chamber. Thus, the dental restoration part is also cooled during the curing process such that the feared yellow coloration due to the heat treatment is reduced reliably or even avoided.

Surprisingly, this is possible although a very intensive exposure to light and accordingly a very short treatment time are provided.

According to the invention it is also favorable that the light sources which give off comparatively much heat are cooled rather towards the end of the air channel. The air passing through the air channel is relatively cold initially, and is heated slightly, for instance by 3 to 5 degrees, for instance in the region of the power supply unit and the power electronics.

At this temperature level, it is supplied to the dental restoration parts which may be cooled well accordingly.

It is only after this that a temperature increase takes place which may amount to up to 20 or even 30 degrees because of the light sources.

If the escaping air is hotter than 60 degrees, it may be preferred to redirect it again additionally for instance to the rear/bottom, to achieve substantial heat dissipation.

The inventive irradiance with for instance 50 or even 160 to 280 milliwatts per square centimeter enables a fast polymerization and tempering or post-tempering process. This ensures inventively that the operating time with respect to known post-tempering devices is reduced considerably, for instance to 5 min, enabling a correspondingly high throughput.

A measurement is performed preferably as follows:

Initially, the emitted light is measured by means of an integrating sphere.

Then, the light source is focused on the measuring sensor.

Its measured value is detected and compared with the measured value of the integrating sphere.

### BRIEF DESCRIPTION

Further advantages, details and features may be taken from the following description of three exemplary embodiments of the invention in conjunction with the drawings, in which:

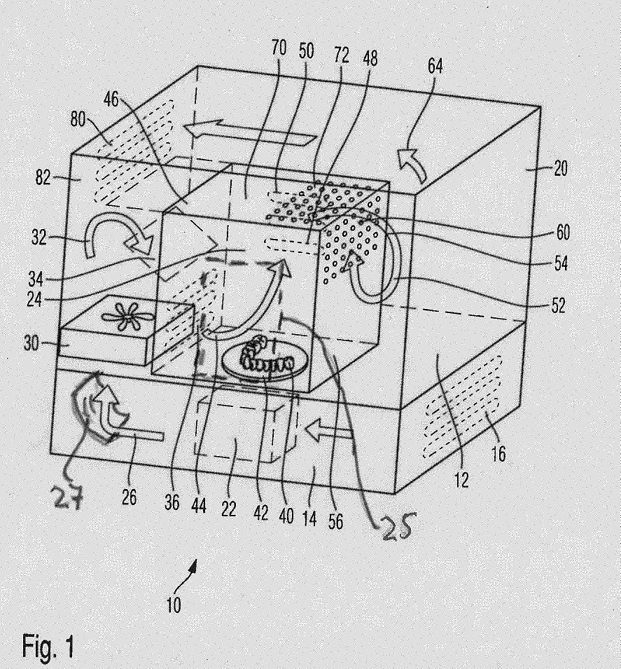

FIG. 1 shows a perspective schematic view of an inventive polymerization and tempering device in one embodiment of the invention;

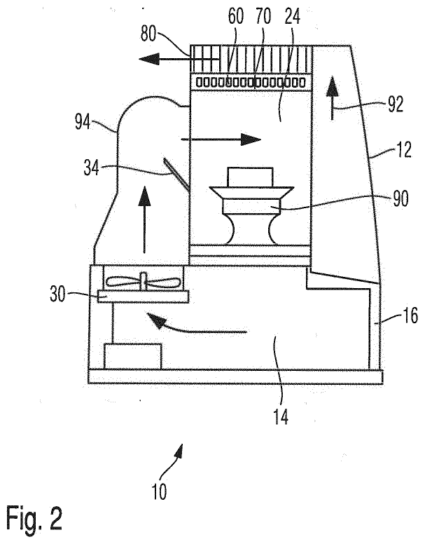

FIG. 2 shows a section through a further embodiment of the invention; and

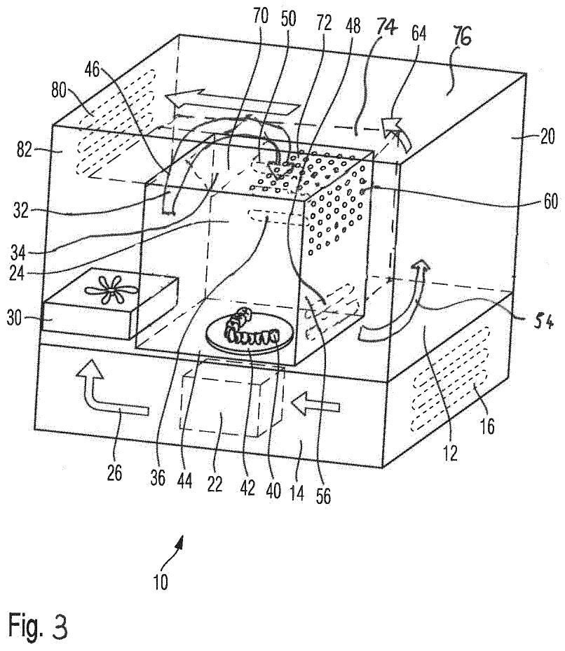

FIG. 3 shows a perspective schematic view of a further polymerization and tempering device in a further embodiment of the invention.

### DETAILED DESCRIPTION

The polymerization and tempering device 10 illustrated in FIG. 1 comprises a housing 12 which is cube-shaped in a way known per se. However, if necessary, any other desired shape of a housing may be used.

An air channel 14 whose configuration is explained in detail herein runs through the housing

The air channel 14 starts at an air inlet 16 at the bottom of the right side wall 20 of the housing 12.

The air channel 14 extends starting from the air inlet 16 through power electronics 22 which may also include an accordingly dimensioned power supply unit. Any power supply capable of serving all electric devices used is suitable, known in the art, such as, but not limited to, semiconductors, e.g., MOSFETS, triacs, thyristors, and the like.

It is arranged in the air channel 14 below a light chamber 24.

From the power electronics 22 further to the left, the air channel 14 extends in the region of a first air redirection 26 in which the flowing air is redirected to the top. For this purpose, air baffles, 27 are provided supportively.

The air channel 14 extends further through a fan 30 which is configured as an axial fan. The axial fan may have fan wheel blades which cover at least 60%, preferably at least 80% of the through-flow area which is configured in the fan.

It extends to the top up to a second air redirection 32. There, it passes over a screen 34 before it enters the light chamber 24 at a light chamber inlet 36.

A dental restoration part 40 is arranged on a rotary plate 42 in the light chamber 24. The air flow sweeps over it wherein a wide redirection 44 takes place thereat because of the guidance of air.

The light chamber inlet 36 is configured at the left side wall 46 of the light chamber 24. It is arranged relatively far to the bottom while a light chamber outlet 48 is configured at a rearward rear wall 50 of the light chamber, namely relatively far to the top.

The air flows in the air channel 14 through the rear wall 50 of the light chamber 24 and is then deflected at a further air redirection 52, the third air redirection, initially towards the right, to reenter the region of the right side wall 20 of the housing.

From there, the air is again deflected to the front, that is to say on the same horizontal plane, however in the direction away from the rear wall 50.

At the right side wall 56 of the light chamber 24 the air flows to the top, such that in this respect a further air redirection 54 takes place.

There, light sources 60 are arranged in the form of a LED matrix. They are installed in the region of the side wall 56 and radiate into the light chamber 24. However, they are plugged into respective holes such that their predominant part is located behind the side wall 56 where both light and the respective heat loss are given off and light is bundled to the front. Although LED lights are preferred, any type of light known in the art, such as bulb lamps, halogen lampes, electric discharge lamps, laser lights and the like, are other examples that may be used.

The heat loss is caught and dissipated by the air channel 14 or else by the air guided thereby.

A fifth air redirection 64 takes place at the upper end of the side wall 56 horizontally to the left, beyond the ceiling wall 70 of the light chamber 24.

There, further light sources 72 are also arranged in the form of a matrix and are cooled in the same way by the air sweeping over them. In this respect, air flows both behind the ceiling wall 70 and the side wall 56 of the light chamber 24.

The air of the air channel 14 sweeps over the entire ceiling wall 70 to the left and also beyond the left side wall 46 of the light chamber.

It reaches an air outlet 80 which is configured in the region of the left side wall 82 of the housing 12.

At this position, the air leaves the polymerization and tempering device 10, heated by the several heat sources, after it has cooled them.

The illustrated air flow is realized by one single fan 30 which is additionally arranged in the interior of the housing 12 spaced apart from the inlets and outlets such that comparatively little air vortex noise produced thereat is heard.

It is to be understood that the light chamber 24 comprises a door 25 towards the front via which the dental restoration part 40 is insertable into the light chamber 24 and removable therefrom.

It may closed with a mechanical seal, such as with a labyrinth seal in a light-proof manner bordering the housing 12.

A further embodiment of the inventive polymerization and tempering device 10 is apparent from FIG. 2. There, the same reference signs refer to the same or respective parts.

The air is sucked in by the fan 30 in the region of the air inlet 16 and flows through the housing 12 along an air channel 14.

It flows through the fan 30 which in turn has a vertically extending axis, and the air enters the light chamber 24 passing a screen 34.

There, a construction platform 90 of a stereolithography device is arranged which carries the dental restoration part 40 for its part. It is cooled by the air flowing over it. The air leaves the light chamber 24 on the opposite side and is guided to the top along the arrow 92. The air flows behind the ceiling wall 70 of the light chamber 24 and cools the light-emitting diodes 60 arranged thereat. The air leaves the housing 12 at an air outlet 80.

It is apparent that, for instance, at the screen 34 the air is redirected by curved shapes which form air baffles 94, low in turbulence and almost laminarly. This serves the flow efficiency of the air wherein the embodiment according to FIG. 2 is also light-proof.

A further embodiment of the inventive polymerization and tempering device 10 is illustrated in FIG. 3.

Here, the same reference signs indicate the same or similar parts as in the further figures.

Up to the fan 30, the course of the air channel 14 corresponds to the embodiment according to FIG. 1.

However, the second air redirection 32 is displaced to the rear, that is to say to the rear wall of the housing 12, just like the screen 34 over which the air flows and which is also configured to be inclined.

In this embodiment, the light chamber inlet 36 for the inflow of the air into the light chamber 24 is configured at the rear wall 50 of the light chamber 24, namely adjacent to the upper wall of the light chamber 24.

The air flows from the top transversely to the bottom over and beyond the dental restoration part 40. Additionally, the air flow flows over the bottom sides of the light sources 72.

On the contrary, the light chamber outlet 48 is configured in the right side wall 56 of the light chamber 24. It is configured relatively far down such that an oblique air flow is produced again, from the top/rear to the bottom/right, that is transversely through the light chamber 24.

Starting from the bottom of the right light chamber side wall 56, the air flows along the right side wall 20 of the housing to the top, wherein initially an air redirection 54 takes place again which redirects the air in the upward direction.

The air flows along the light sources 60 at the light chamber side wall 56. It is in turn deflected by a further air redirection 64 at the upper end of the light chamber/side wall 56 horizontally to the left, sweeps over the ceiling wall 70 of the light chamber 24 and cools the further light sources 72 thereat.

In this respect, in this embodiment, too, air flows both behind the right side wall 56 of the light chamber 24 and behind the ceiling wall 70 of the light chamber 24, that is to say behind all the walls of the light chamber 24 equipped with light sources 60 or 72, respectively.

As is known, the LED chips are the heat sources of light sources 72, and they are located behind the respective mounting walls 56 and 70, and are thus cooled purposefully by the air flow.

In this configuration, a partition wall 74 lengthened to the rear is provided which separates the air on the inlet side of the light chamber 24 and on the outlet side of the light chamber 24 from one another. It extends horizontally but also along the right side wall 56 of the light chamber 24 towards the bottom and basically prolongs the substantially cube-shaped light chamber 24 up to the rear wall 76 of the housing.

It is to be understood that fluidic measures known per se may be used to adapt the speed of flow within the air channel 24 to the requirements.

For instance, the cross-section of the air channel 24 may be tapered in the region of the light sources 60 and 72 but also in the region of the power electronics 22. The then high speed of flow thereat produces intensive vortices which favor the exchange of heat. Smaller frictional losses are caused thereat by the comparatively lower speed of flow in the remaining regions of the air channel 24, in particular in the region of the flow redirections 26, 32, 54 and 64.

In this respect, it is inventively favorable to alternate between flow calming zones and heavy flow zones.

In this respect, it is also favorable to provide long straight and uniform flow paths respectively both adjacent to the air inlet 16 and to the air outlet 80—each over the entire width of the housing 12—such that the speeds of flow are low adjacent to the inlet 16 and the outlet 80, respectively, due to the large flow areas thereat, respectively.

1. A polymerization and tempering device for tempering dental restoration parts made of polymerizable plastics, comprising
at least one light source which emits light in the visible and/or ultraviolet wavelength range,
a fan for cooling the polymerization and tempering device,
a light chamber in which at least one wall is equipped with the at least one light source,
a door to the light chamber with a placement location for dental restoration parts,
wherein the fan is arranged in an air channel which extends through a housing of the polymerization and tempering device.

2. The polymerization and tempering device as claimed in claim 1,
wherein tempering comprises post-tempering,
wherein the dental restoration parts are produced by stereolithography,
wherein the at least one wall comprises at least one of a ceiling wall, a bottom wall and a side wall,
wherein the fan blows air behind at least the light source wall.

3. The polymerization and tempering device as claimed in claim 1,
wherein the polymerization and tempering device is light-proof.

4. The polymerization and tempering device as claimed in claim 1,
wherein the air channel extends transversely through the housing of the polymerization and tempering device, from an air inlet to an air outlet,
wherein the air inlet and the air outlet are arranged at different walls comprising a ceiling wall, a bottom wall, and/or a side wall of the housing.

5. The polymerization and tempering device as claimed in claim 4,
wherein the air inlet and the air outlet are arranged at walls opposite one another.

6. The polymerization and tempering device as claimed in claim 1,
wherein the air channel extends through a plurality of heat sources which are cooled consecutively by cooling air which may be sucked in through the air inlet.

7. The polymerization and tempering device as claimed in claim 1,
wherein the fan is arranged in the air channel before, after or between two heat sources,
wherein one of the heat sources comprises a power supply unit and/or power electronics.

8. The polymerization and tempering device as claimed in claim 1,
wherein the air channel extends through the light chamber and
wherein the light chamber comprises a light chamber inlet and a light chamber outlet which are attached to different walls of the light chamber.

9. The polymerization and tempering device as claimed in claim 1,
wherein between the light chamber and the air outlet on the one hand and the light chamber and the air inlet on the other hand at least two redirections of the air channel are configured.

10. The polymerization and tempering device as claimed in claim 1,
wherein the light source emits an irradiance of at least 50 milliwatts per cm² onto the dental restoration part.

11. The polymerization and tempering device as claimed in claim 10,
wherein the light source emits an irradiance in the range of 160 to 280 milliwatts per cm², with help of an integrating sphere.

12. The polymerization and tempering device as claimed in claim 1,
wherein the door to the light source is provided with a labyrinth seal circumferentially.

13. The polymerization and tempering device as claimed in claim 1,
wherein the air channel is dyed or coated to be black on the inside, and/or
wherein the light chamber is mirrored on the inside.

14. The polymerization and tempering device as claimed in claim 1,
wherein adjacent to the light chamber inlet and/or the light chamber outlet outside of the light chamber a screen is attached which points obliquely to the outside starting from the wall of the light chamber and produces additional redirection of air by shading or blocking the light incident through the light chamber inlet and/or the light chamber outlet.

15. The polymerization and tempering device as claimed in claim 14,
wherein the screen comprises a black screen.

16. The polymerization and tempering device as claimed in claim 1,
wherein the light sources are attached to at least a ceiling wall of the light chamber and a side wall of the light chamber and comprise a plurality of light-emitting diodes arranged in a grid.

17. The polymerization and tempering device as claimed in claim 1,
wherein the air channel extends along the outside of at least two walls of the light chamber adjacent to one another, at least along walls which comprise light sources.

18. The polymerization and tempering device as claimed in claim 17,
wherein the air channel extends along the outside of three or more walls of the light chamber.

19. The polymerization and tempering device as claimed in claim 1,
wherein the air channel comprises a fan and extends through the power electronics, including the power supply unit, through the light chamber and beyond the light sources which each form heat sources.

20. The polymerization and tempering device as claimed in claim 1,
wherein the fan is configured as an axial fan comprising fan wheel blades which cover at least 60% of the through-flow area which is configured in the fan.

21. The polymerization and tempering device as claimed in claim 1,
wherein the light chamber comprises a rotary plate at a bottom wall with which the dental restoration parts may be rotated during the polymerization process.

22. The polymerization and tempering device as claimed in claim 21,
wherein the rotary plate is sized and the light chamber is sized such that a construction platform of a stereolithography apparatus may be placed on the rotary plate enabling free rotation of the construction platform.

23. A polymerization and tempering device for tempering comprising post-tempering, of dental restoration parts made of polymerizable plastics, which parts may be produced by stereolithography, comprising
at least one light source which emits light in the visible and/or ultraviolet wavelength range,
a fan for cooling the polymerization and tempering device,
a light chamber in which at least one wall is equipped with the at least one light source, and
a door to the light chamber,
wherein the polymerization and tempering device is configured to be light-proof,
wherein the fan is arranged in an air channel which is provided with at least one redirection between an air inlet and the light chamber on the one hand and an air outlet and the light chamber on the other hand, and
wherein the air channel extends through the light chamber and the irradiance of the light chamber amounts to at least 30 milliwatts per cm².
